(19) United States
(12) Patent Application Publication
(10) Pub. No.: US 2006/0137232 A1
(43) Pub. Date: Jun. 29, 2006

(54) Structural part for a structural arrangement

(76) Inventor: Roy Neville Mann, Umhlanga Rocks (ZA)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/561,402

(22) PCT Filed: Jun. 14, 2004
(86) PCT No.: PCT/IB04/01951

§ 371 Date: Dec. 15, 2005

(30) Foreign Application Priority Data
Jun. 20, 2003 (ZA) 2003/4826
Jan. 30, 2004 (ZA) 2004/0788

(51) Int. Cl. G09F 15/00

(52) U.S. Cl. 40/610

(57) ABSTRACT

The invention relates to a structural part for a structural arrangement (10), the structural part (10) including a generally rectangular frame formed of four resiliently flexible frame elements (12.1, 12.2) connected together at their ends by connector pieces (14) that form the corners of the frame. The structural part includes also a flexible sheet element that is securely located on the frame and that spans the frame. The structural part (10) is collapsible by performing a manual twisting and folding operation on the frame to thereby provide a compact storage configuration of the structural part. A structural part (10) as defined, by itself or in combination with other similar structural parts or other components, can form a part of various different structural arrangements including a display device, a gazebo, a carport, and the like, these arrangements all permitting collapse into a more compact storage configuration by collapse of the or each structural part forming a part thereof.

THIS INVENTION relates to a structural part for a structural arrangement.

The invention relates particularly to a structural part for a structural arrangement that is made up of a closed frame having a flexible sheet element located on and spanning the frame. The structural part thus forms a panel-like structure that can form a structural part of a generally light weight, easily portable structural arrangement such as a banner-type display device, a gazebo, a carport, a merchandising container, and the like.

A closed frame as herein envisaged comprises a frame formed of one or more elongate frame element that defines an enclosed space within the frame, that can be covered by a flexible sheet element by its location on the frame. Any reference hereinafter to a closed frame must be interpreted as such.

A known banner-type display device of the general type herein envisaged comprises a closed frame formed of an elongate resiliently flexible element that, without a flexible sheet element located thereon, will define a generally circular configuration and with a flexible sheet element located thereon, defines a closed loop profile as determined by the perimeter profile of the sheet element, e.g. an oval profile, the frame particularly being located in a seam formation defined by the sheet element around the perimeter thereof that provides for the required location of the sheet element on the frame.

With the frame element of such a closed loop frame having suitable resilient flexibility and a suitable cross-sectional profile, collapse of the frame is permitted by performing a twisting and folding action thereon, either into a two-loop or a three-loop compact configuration, suitable for transport and storage of the display device. Insofar as the general configuration of such a display device is well known, the display device is not described in further detail herein.

The loop configuration of the frame of a display device as above envisaged clearly is space inefficient in relation to the “amount” of display matter than can be applied to the sheet element thereof, e.g. advertising matter, and the like, and the stable support of the device in a display configuration also is relatively difficult to achieve. Furthermore, insofar as the frame and sheet element form a panel-like structure, the loop configuration of the frame, which constitutes the perimeter profile of the panel-like structure, clearly does not render the panel-like structure readily usable for other applications, where it can form part of a structural arrangement of the type herein envisaged, other than a banner-type display device. It is well known in this regard that the configurations of the closed frames of the display devices of the above type have varied from circular to various oval-like configurations, these frames thus always being closed loop-type frames, a closed-loop configuration for such frames always having been considered essential in relation to collapse of a panel-like structure including such a frame into a more compact transport and storage configuration. The abovementioned disadvantages associated with display devices of the type and particularly also panel-like structures of the type have thus never been dealt with or overcome.

According to the invention there is provided a structural part for a structural arrangement, which includes an angular frame formed of resiliently flexible frame segments that each define a segment of the frame between two corners thereof, and a flexible sheet element that is securely located on the frame and that spans the frame, the structural part being collapsible by performing a manual twisting and folding operation on the frame to thereby provide a compact storage configuration of the structural part.

A preferred embodiment of the structural part for a structural arrangement, in accordance with the invention, provides for the angular frame thereof to be a rectangular frame defined by four frame segments. As such, each frame segment of the angular frame may comprise an elongate, resiliently flexible frame element and the frame elements may be connected together at their ends by connector pieces that form the corners of the angular frame.

The frame elements forming the frame segments of an angular frame of a structural part typically is formed of a carbon fibre reinforced material, although the frame elements clearly can be formed of any other resiliently flexible material that will permit collapse of the frame by performing a manual twisting and folding operation thereon.

Further according to the invention, the frame of the structural part may include at least one elongate reinforcing element that extends across a pair of frame elements for enhancing the stability of the frame, the configuration and the location of the reinforcing element being such that collapse of the frame is still permitted.

The at least one elongate reinforcing element particularly extends across a pair of opposite, parallel frame elements, where the angular frame is a rectangular frame.

The flexible sheet element of the structural part of the invention may be formed of any one of a natural fabric material, a synthetic fabric material, a synthetic plastics material, and the like.

Insofar as the structural part may form a part of a display device, the flexible sheet element may have printed display matter applied thereto, typically by a suitable printing process.

The invention extends also to a structural arrangement which includes a structural part which incorporates all the features of the structural part as hereinabove defined.

Such a structural arrangement may include at least two structural parts that are securely inter-engaged with one another in the operative configuration of the structural arrangement. Particularly, the structural parts may be inter-engaged by the engagement of the flexible sheet elements thereof.

A particular arrangement of a structural arrangement including at least two structural parts and where each structural part includes a rectangular frame defined by four frame segments that each comprises an elongate resiliently flexible frame element and the frame elements are connected together at their ends by connector pieces that form the corners of the angular frame, the two frames of the structural parts may include a common frame element, the connector pieces permitting folding of the frames of the structural parts onto one another.

The structural arrangement of the invention may provide also for the structural parts to fold onto one another and thereby to permit simultaneous collapse of the structural pairs by performing a twisting and folding operation on the frames thereof.

A structural arrangement, in accordance with the invention, also may include spacer elements that hold structural parts in a spaced configuration with respect to one another in an operative configuration of the structural arrangement. Still further, such a structural arrangement may include legs that can hold at least one structural part of the arrangement at an elevated level above a ground surface. As such, the structural arrangement may be configured to serve the purpose of one of a gazebo, a cover for a vehicle, and a general shade structure.

The structural parts of the structural arrangement of the invention also may be interconnected and configured in a configuration in which they form an enclosed compartment between them. As such, the structural arrangement may serve the purpose of a merchandising container, although when provided in the form of an enclosed compartment, the arrangement clearly can serve various other purposes also.

For a structural arrangement in which the flexible sheet element of at least one structural part has display matter applied thereto, the structural arrangement particularly can serve the purpose of a display device, many different display devices including structural parts having display matter applied thereto being envisaged. For example, such a display device may include two structural parts that are interconnected and that can form an A-frame configuration when viewed in end view, for its support on a ground surface.

Also for a structural arrangement that serves the purpose of a display device, the structural arrangement may include support means for supporting the structural part thereof that has display matter applied thereto, in an operative display configuration. The support means typically may include legs or any other support means, whereby one or more structural part can be supported in an upright configuration on a ground surface, to permit it to fulfil a display function.

The features of a structural part for a structural arrangement, as well as the configuration of various different structural arrangements including at least one structural part, are explained and described in more detail hereinafter, by way of examples thereof, that are illustrated in the accompanying diagrammatic drawings. In the drawings:

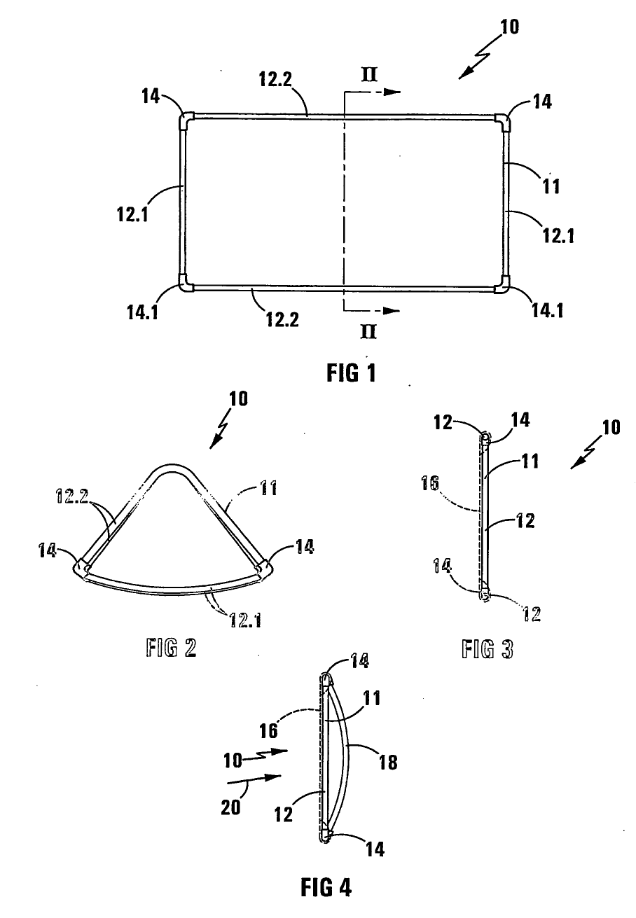

FIG. 1 shows an elevational front view of a structural part for a structural arrangement, in accordance with the invention, in an unfolded configuration thereof;

FIG. 2 shows the structural part of FIG. 1, in a collapsed folded configuration thereof;

FIG. 3 shows a cross-sectional side view of the structural part of FIG. 1, along line II-II of FIG. 1, having a display element securely located thereon;

FIG. 4 shows a side view of the structural part of FIG. 1, having a reinforcing member releasably located with respect thereto;

FIG. 5 shows an elevational view of the structural part of FIG. 1, having two different embodiment reinforcing members located with respect thereto;

FIG. 6 shows a side view of a corner region of the structural part of FIG. 1, having a foot formation releasably connected therewith, permitting use of the structural part as a structural arrangement in the form of a display device;

FIG. 7 shows an elevational front view of the corner region of the structural part of FIG. 6, together with the foot formation;

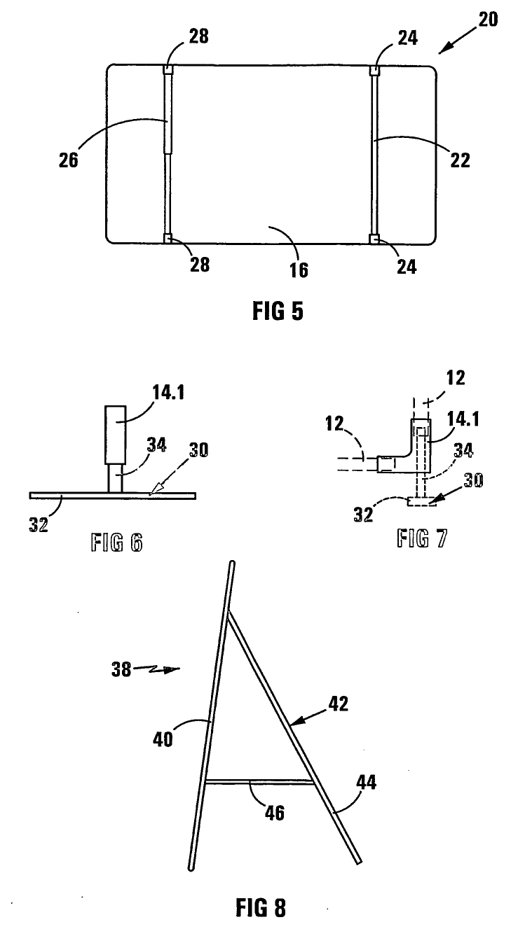

FIG. 8 shows a side view of a structural arrangement in the form of a display device, including a structural part as shown in FIG. 1;

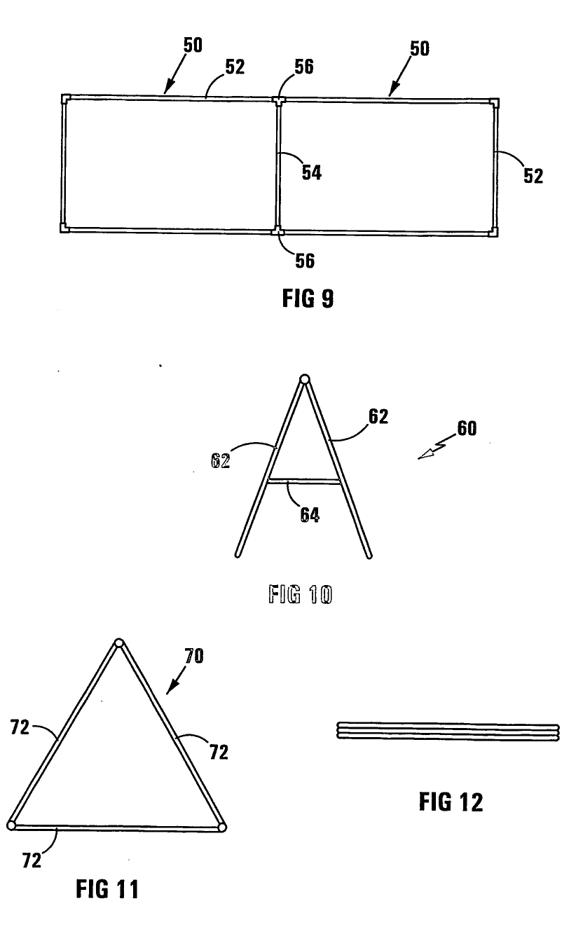

FIG. 9 shows an elevational front view of a structural arrangement including two interconnected structural parts as shown in FIG. 1;

FIG. 10 shows a structural arrangement, in the form of a display device, including two structural parts as shown in FIG. 1;

FIG. 11 shows a plan view of a structural arrangement in the form of a display device, including three structural parts as shown in FIG. 1;

FIG. 12 shows the structural arrangement of FIG. 10, in a partially collapsed configuration;

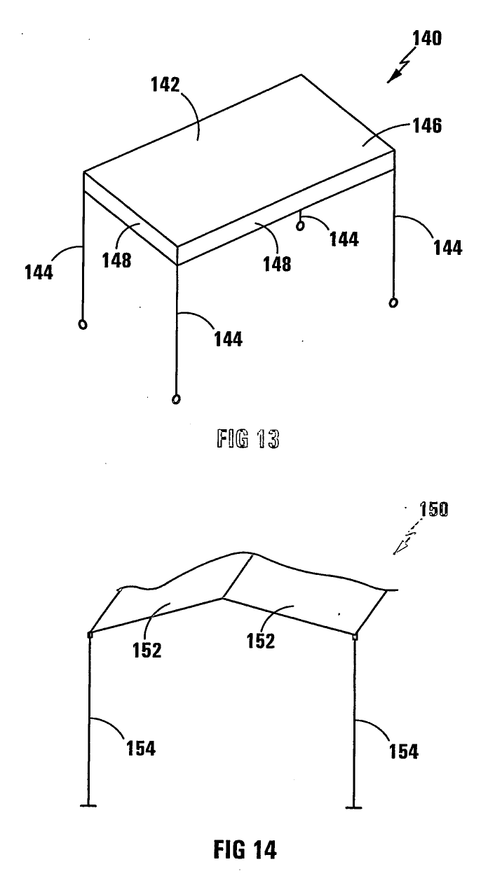

FIG. 13 shows a three-dimensional view of a structural arrangement in the form of a gazebo, including a structural part as shown in FIG. 1;

FIG. 14 shows a three-dimensional view of a structural arrangement in the form of a carport, including two structural parts as shown in FIG. 1; and

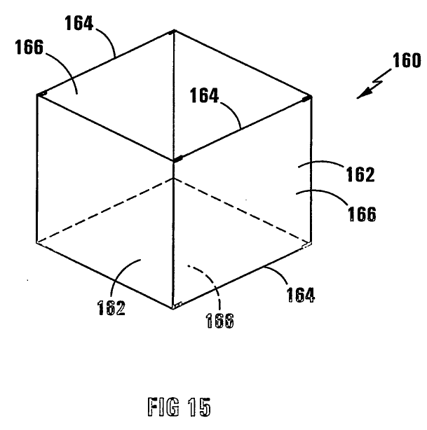

FIG. 15 shows a three-dimensional view of a structural arrangement in the form of a merchandising container, including two structural parts as shown in FIG. 1.

Referring initially to FIGS. 1 and 2 of the drawings, a structural part, in accordance with the invention, is designated generally by the reference numeral 10. The structural part 10 includes a frame 11, the frame 11 comprising four, substantially linear, frame elements 12 that form a rectangular frame structure by being connected together, in the configuration as shown, by means of connector pieces 14.

The frame elements 12 are formed of a resiliently flexible material, e.g. spring steel or a carbon fibre reinforced material, the resilient flexibility of the frame elements 12 being such that they can maintain the frame 11 in the rectangular frame structure configuration as shown in FIG. 1, while still permitting the collapse of the structural part 10 into a collapsed configuration, substantially as shown in FIG. 2, by performing a manual twisting and folding operation on the frame 11. The twisting and folding operation particularly applies to the longer frame elements 12.2 and result in the shorter frame elements 12.1 to be effectively folded onto one another.

Referring also to FIG. 3 of the drawings, the structural part 10, including the frame 11, includes also a substantially rectangular sheet element 16 (only shown in dotted lines) the sheet element spanning the frame 11 when disposed in its configuration as shown in FIG. 1. The sheet element 16 is provided with seam formations around the perimeter thereof by a stitching or other suitable operation, the frame elements 12 being located within these seam formations for the secure location of the sheet element 16 on the frame 11. The sheet element can be formed of any suitable sheet material and typically is formed of a synthetic plastics sheet material, or a natural or synthetic fabric sheet material. The sheet element, in use as part of a banner part of a display banner, has display matter applied thereto by a printing or other process, which display matter can be displayed by the structural part when supported in a display configuration which, generally, will be a substantially upright configuration.

It must be understood that the resilient flexibility of the frame elements 12 forming the frame 11 of the structural part 10, which is essentially determined by the material of which these elements are formed, the cross-sectional profile of these elements and the cross-sectional dimensions of these elements, must be optimized to provide for these elements being able to maintain the rectangular frame structure configuration of the frame 11 when having a sheet element 16 located thereon, while still permitting manual collapse without requiring excessive force. In order to enhance the required rigidity of the frame, the angular configuration of the connector pieces 14 may provide for the angle between adjacent frame elements, 12.1 and 12.2, to be marginally in excess of 90°, providing for the frame elements 12.2 to “bow slightly outwardly” and hence provide for a more rigid frame.

Although a frame 11 of a structural part 10 as above envisaged is considered to have sufficient rigidity to serve as part of a structural arrangement, e.g. a display device, where the frame is relatively small, it is envisaged that for larger frames a reinforcing member may be provided to act between frame elements, for enhancing the effective rigidity of the frame. As such, and referring particularly to FIG. 4 of the drawings, in relation to the frame 11 of the structural part 10, a reinforcing member 18 is provided to act between the parallel frame elements 12.2 for securing the spacing between these 20 elements and thereby enhancing the rigidity of the frame 11. The particular reinforcing member 18 has its opposite ends located with respect to the frame elements 12.2 via pocket formations (not clearly shown) provided on the sheet element 16 that is securely located on the frame 11. It is envisaged in this regard also that a reinforcing member may have one of its ends securely located with respect to the remainder of the structural part, while its other end is releasably engageable for holding the reinforcing member in its operative configuration.

The reinforcing member 18 as shown bows outwardly with respect to the general plane of the structural part 10 including the frame 11, thus being spaced from the sheet element 16. This spacing reduces the visibility of the reinforcing member 18 when viewing display matter applied to the sheet element 16 from the operative frontface side of the sheet element 16, i.e. in the direction of arrow 20, where the structural part forms a part of a display device. It will be understood that many different configuration reinforcing members can be associated with a structural part of the type hereinabove described and in this regard it is envisaged in particular that the frame of the structural part can be associated with two or more reinforcing members, where this may be required in terms of the size of the structural part with which the frame is associated and/or the intended application of the structural part, either as part of a display device, or otherwise.

Referring in the above regard particularly to FIG. 5 of the drawings, in relation to a structural part, generally indicated by the numeral 20, that has a frame as described above on which a flexible sheet element 16 is located, the structural part has reinforcing members acting between the operative longer frame elements of the frame, two different configuration reinforcing members being shown. The one reinforcing member 22 acts between the longer frame elements and merely comprises a linear element that has its opposite ends located in pocket formations 24 that are provided for on the sheet element 16, the reinforcing member being entirely removable, to still permit collapse of the associated frame. Alternatively, one end of the reinforcing member may be secured within its pocket formation and the other end may be removable from its pocket formation, again permitting normal collapse of the associated frame, the reinforcing member 22 clearly being essentially the equivalent of the reinforcing member 18, as described with reference to FIG. 4 of the drawings, but not being bowed.

The other reinforcing member 26 also acts between the longer frame elements, opposite ends of this reinforcing member being secured within pocket formations 28 provided therefor by the flexible sheet element 16. The reinforcing member 26 is made up of two telescopically displaceable, tubular parts that are spring loaded into the configuration as shown and that permit relative displacement of the parts in order to accommodate required collapse of the associated frame of the support structure 20. It is envisaged in this regard also that two parts forming a reinforcing member, equivalent to the member 26, may be releasably interconnected at their free ends, where release provides for collapse of the associated frame or, alternatively, may be pivotally connected to serve in a similar manner to the reinforcing member 26, as described. Clearly, the mode of reinforcing a structural part, in accordance with the invention, will be determined by the structural arrangement with which the structural part is to be associated and can thus be greatly varied.

Referring now to FIGS. 6 and 7 of the drawings, a structural part, in accordance with the invention, when used as a display device, can include two feet formations 30 (only one shown) that provide for the support of the structural part in an operative upright display configuration. Each foot formation includes an elongate base member 32 and a leg 34, the leg being telescopically received within a passage formation defined therefore by a corner piece 14.1 that is provided at the operative lower end of the frame of the structural part, for connecting the frame elements 12 of the frame together (see also FIG. 1). The mode of location of feet formations clearly is greatly variable. The feet formations may be completely removable from the frame, or may be securely located with respect thereto. It is envisaged also that the location of the feet formations with respect to the frame of the structural part can be rendered adjustable, thus effectively rendering the structural part including the frame height adjustable, as may be required for different display configurations of an associated display device. It will be understood in this regard that many different configuration feet formations can be provided for the purpose described and can be associated with a structural part, including a frame as described, for forming a structural arrangement such as a display device, or the like.

Referring to FIG. 8 of the drawings, a structural arrangement in the form of a display device, is designated generally by the reference numeral 38. The structural arrangement includes a structural part 40 and a stand 42, the stand providing for the support of the structural part in an operative upright display configuration. The stand 42 includes legs 44 (only one leg being visible) and cross members 46, the cross members providing for the legs to be held in their required angular configuration with respect to the structural part 40, in order to support the structural part 40 in its display configuration. It is envisaged that the stand 42 can be provided as a separate unit that is independently collapsible and/or foldable into a more compact configuration, also permitting the structural part to be folded into a more compact configuration as shown in FIG. 2. Once again, it will be appreciated that many different configurations of stands can be associated with structural parts for supporting the structural parts in a display configuration to serve the purpose of a display device and in this regard both the feet formations as described with reference to FIGS. 6 and 7 and stand as described with reference to FIG. 8 can be associated with combinations of structural parts that are inter-engaged with one another, for supporting these structural parts in a display configuration.

It is ordinarily envisaged that if two or more structural parts are to be used in combination with one another for forming a structural arrangement, such as a display device, that these structural parts will be connected with one another via the display elements thereof, by suitable stitching, or the like. However, a preferred embodiment of such a structural arrangement, as shown in FIG. 9, provides for the frames of the structural parts thereof to be provided with a common frame element. FIG. 9 particularly shows two structural parts 50 that each has a frame 52 that is essentially the equivalent of the frame 11 as shown in FIG. 1 of the drawings. However, the frame element 54 of the respective frames 52 constitute a common element to both the frames 52, the connector pieces 56 particularly being configured to permit one frame 52 to fold onto the other frame 52, in which configuration the two structural parts 50 can be simultaneously collapsed into a collapsed configuration, essentially as shown in FIG. 2.

It will be understood in the above regard that a structural arrangement, in the form of a display device and including the structural parts 50, (the display elements of which are not shown in FIG. 9), can be supported in a display configuration in various modes, either via separate support means such as feet formations as shown in FIG. 6 and 7, or a stand as shown in FIG. 8, or merely by positioning the two structural parts 50 at an angle to one another, which will permit the structural parts to effectively become self supporting in their display configuration.

FIG. 10 shows a structural arrangement in the form of a display device that is designated generally by the reference numeral 60, the arrangement 60 again including two structural parts 62 that are connected together along their longitudinal edges, the two structural parts 62 either being associated with totally separate frames or frames having a common frame element. Where associated with a common frame element, a single sheet element can serve to span the frames of both the structural parts 62, by the suitable location thereof with respect to the frames. The two structural parts 62 permit support in an A-frame configuration when viewed in side view and as shown, a flexible element 64 extending between the structural parts 62 for securing the angular configuration of the structural parts in their display configuration.

It is submitted that many different configuration structural arrangements that can serve as display devices can be provided by combining structural parts, incorporating frames as described with reference to FIG. 1, with one another, FIG. 11 illustrating in plan view the configuration of a structural arrangement 70 that serves the purpose of a display device and that includes three structural parts 72, that are arranged in the triangular configuration as shown, in which they effectively support themselves. It will be understood that one of the structural parts 72 will have the other two structural parts inter-engaged therewith, the free ends of the said other two structural parts being releasably connectable with one another for holding the structural arrangement 70 in the configuration as shown. By releasing the connected ends of the said other two structural parts 72, the three structural parts can be collapsed into a configuration as shown in FIG. 12, in which they are folded flat onto one another, again permitting the collapse of the three structural parts, together, into a configuration substantially as shown in FIG. 2.

Referring now to FIG. 13 of the drawings, a structural arrangement, including a structural part as above described, is designated generally by the reference numeral 140. The structural arrangement 140 comprises a gazebo that is formed of one structural part 142 that incorporates a collapsible frame as above described, the connector pieces of the structural part 142 providing also for the location of four legs 144, whereby the structural part can be held in its elevated position as shown, to permit its application as a gazebo. The legs 144 may be removable or hingedly displaceable, in order to still permit required collapse of the structural part 142 into a compact storage configuration of the structural arrangement. The flexible sheet element of the structural part 146 also may extend downwardly along the legs 144, as shown, the extension segment 148 serving also to enhance the stability of the structural arrangement. It will be understood in this regard that by providing extension segments that extend further downwardly, particularly to the ground, a structural arrangement in the form of an enclosed compartment is provided. One or more of the extension segments can then be configured to provide for access into such a compartment.

Referring to FIG. 14 of the drawings, a further structural arrangement, including structural parts as above described, is designated generally by the reference numeral 150. The arrangement 150 serves the purpose of a carport and includes two structural parts 152 and four legs 154 (only two shown). The structural arrangement particularly can serve as a carport with the structural parts 52 serving as a roof thereof. The two structural parts are parts as described above and of which the flexible sheet elements are connected together by stitching, or the like, the parts thus being foldable onto one another to permit simultaneous collapse into a compact storage configuration. It is envisaged also that the two structural parts 52 may include a common frame element, the connector pieces hence associated with the frames of the structural parts 152 again permitting folding of the structural parts onto one another, to permit simultaneous collapse thereof. Once again, the legs 154 either may be removably or displaceably located with respect to the structural parts, thus not to interfere with the required collapse of the structural parts. It will again be appreciated that with the suitable use of flexible sheets between the legs 54, structural arrangements in the form of compartments can be provided for different purposes.

Referring particularly to FIG. 15 of the drawings, a further structural arrangement, including structural parts as described above, is designated generally by the reference numeral 160. The structural arrangement is in the form of an open-topped container and includes two structural parts 162 that are held in a spaced configuration by spacer elements 164, the spacer elements cooperating with the connector pieces of the structural parts 162 for their location as shown. The spacer elements 164 typically are removable in order to permit the collapse of the structural parts 162 onto one another for further collapse into a compact storage configuration, flexible sheets effectively connecting the structural parts 162 to one another with the spacer elements providing required rigidity of the structural arrangement. It is envisaged that the structural arrangement, which is in the form of an open topped container, can be used for many different applications including merchandising, products storage, and the like.

It will understood from a consideration of all the structural arrangements as above described that numerous different structural arrangements can be provided that include one or more structural parts, where these parts are operatively interconnected while permitting collapse of the parts into a configuration in which the structural arrangement can be collapsed into a compact storage configuration, in which storage, handling and transport thereof is facilitated. It will be appreciated in this regard also that structural parts of structural arrangements may be completely separable, in which case structural arrangements will be collapsible into two or more separate units that are interconnected only in the operative configuration of the structural arrangements. Particularly by the location of flexible sheet elements between structural parts, spacer elements and/or legs as envisaged above, various different configuration structural arrangements can be achieved, the invention extending particularly to any structural arrangement that includes at least one structural part as envisaged and that can be collapsed into a compact storage configuration as envisaged, through the collapse of the or each structural part by performing a manual twisting and folding operation on the frame thereof.

1. A structural part for a structural arrangement, which includes an angular frame formed of resiliently flexible frame segments that each define a segment of the frame between two comers thereof, and a flexible sheet element that is securely located on the frame and that spans the frame, the structural part being collapsible by performing a manual twisting and folding operation on the frame to thereby provide a compact storage configuration of the structural part.

2. A structural part as claimed in claim 1, in which the angular frame is a rectangular frame defined by four frame segments.

3. A structural part as claimed in claim 1 or claim 2, in which each frame segment of the angular frame comprises an elongate, resiliently flexible frame element and the frame elements are connected together at their ends by connector pieces that form the corners of the angular frame.

4. A structural part as claimed in claim 3, in which the frame elements are formed of a carbon fibre reinforced material.

5. A structural part as claimed in any one of claims 2 to 4, in which the frame includes at least one elongate reinforcing element that extends across a pair of frame elements for enhancing the stability of the frame, the configuration and the location of the reinforcing element being such that collapse of the frame is still permitted.

6. A structural part as claimed in claim 5, in which the at least one elongate reinforcing element extends across a pair of opposite, parallel frame elements.

7. A structural part as claimed in any one of the preceding claims, in which the flexible sheet element is formed of one of a natural fabric material, a synthetic fabric material, and a synthetic plastics material.

8. A structural part as claimed in any one of the preceding claims, in which the flexible sheet element has printed display matter applied thereto.

9. A structural arrangement which includes a structural part, the structural part including an angular frame formed of resiliently flexible frame segments that each define a segment of the frame between two corners thereof, and a flexible sheet element that is securely located on the frame and that spans the frame, the structural part being collapsible by performing a manual twisting and folding operation on the frame to thereby provide a compact storage configuration of the structural part.

10. A structural arrangement as claimed in claim 9, in which the angular frame of the structural part is a rectangular frame defined by four frame segments.

11. A structural arrangement as claimed in claim 9 or claim 10, in which each frame segment of the angular frame of the structural part comprises an elongate, resiliently flexible frame element and the frame elements are connected together at their ends by connector pieces that form the corners of the angular frame.

12. A structural arrangement as claimed in claim 11, in which the frame elements are formed of a carbon fibre reinforced material.

13. A structural arrangement as claimed in any one of claims 10 to 12, in which the frame of the structural part includes at least one elongate reinforcing element that extends across a pair of frame elements for enhancing the stability of the frame, the configuration and the location of the reinforcing elements being such that collapse of the frame is still permitted.

14. A structural arrangement as claimed in claim 13, in which the reinforcing element extends across a pair of opposite, parallel frame elements.

15. A structural arrangement as claimed in any one of claims 9 to 14, in which the flexible sheet element of the structural part is of one of a natural fabric material, a synthetic fabric material and a synthetic plastics material.

16. A structural arrangement as claimed in any one of claims 9 to 15, in which the flexible sheet element of the structural part has display matter applied thereto.

17. A structural arrangement as claimed in any one of claims 9 to 16, which includes at least two structural parts that are securely inter-engaged with one another in the operative configuration of the structural arrangement.

18. A structural arrangement as claimed in claim 17, in which the structural parts are inter-engaged by the engagement of the flexible sheet elements thereof.

19. A structural arrangement as claimed in claim 17, in which the at least two structural parts each include a rectangular frame defined by four frame segments that each comprise an elongate resiliently flexible frame element and the frame elements are connected together at their ends by connector pieces that form the corners of the rectangular frame and in which the two frames of the structural parts include a common frame element, the connector pieces permitting folding of the frames of the structural parts onto one another.

20. A structural arrangement as claimed in claim 17 or claim 18, in which the structural parts can fold onto one another to permit simultaneous collapse thereof by performing a twisting and folding operation on the frames thereof.

21. A structural arrangement as claimed in claim 17, which includes spacer elements that hold structural parts in a spaced configuration with respect to one another in an operative configuration of the structural arrangement.

22. A structural arrangement as claimed in any one of claims 9 to 21, which includes legs that can hold at least one structural part of the arrangement at an elevated level above a ground surface.

23. A structural arrangement as claimed in claim 22, which is configured to serve the purpose of one of a gazebo, a cover for a vehicle, and a general shade structure.

24. A structural arrangement as claimed in claim 17, in which structural parts of the structural arrangement are inter-connected and configured in a configuration in which they form an enclosed compartment between them.

25. A structural arrangement as claimed in any one of claims 9 to 24, in which the flexible sheet element of at least one structural part has display matter applied thereto and the structural arrangement serves the purpose of a display device.

26. A structural arrangement as claimed in claim 25, which includes support means for supporting the structural part having display matter applied thereto in an operative display configuration.

27. A structural part for a structural arrangement substantially as described in the specification with reference to and as illustrated in the accompanying drawings.

28. A structural arrangement substantially as described in the specification with reference to and as illustrated in the accompanying drawings.
